(19) United States
(12) Patent Application Publication
(10) Pub. No.: US 2005/0036622 A1
(43) Pub. Date: Feb. 17, 2005

(54) Field deployable wireless networking device

(75) Inventors: Richard Allen Hay, Oak Hill, VA (US); Brian Lawrence Smith, Fairfax, VA (US)

Correspondence Address: BANNER & WITCOFF, 1001 G STREET N W, SUITE 1100, WASHINGTON, DC, 20001, US

(73) Assignee: Superlative Technologies, Inc. (SuprTek), McLean, VA (US)

(21) Appl. No.: 10/740,460

(22) Filed: Dec. 22, 2003

Related U.S. Application Data
(60) Provisional application No. 60/495,119, filed on Aug. 15, 2003.

(51) Int. Cl. H04K 1/00

(52) U.S. Cl. 380/270

(57) ABSTRACT

Apparatuses and systems for wireless networking connectivity are disclosed. A wireless networking apparatus has a weatherproof housing that protects a radio transceiver module, a network router, and an encryption module. The encryption module provides secure data encryption and the radio transceiver module transmits and receives data wireless. The wireless networking apparatus also has a securing device, such as a tripod stand, allowing a user to mount the wireless networking device in a stable fashion. Two wireless networking devices can operate as ends to a point-to-point bridge, connecting distance networks together.

This application claims priority to provisional U.S. Application Ser. No. 60/495,119, filed Aug. 15, 2003, entitled “FIELD DEPLOYABLE WIRELESS NETWORKING UNIT”, herein incorporated by reference for all purposes.

### FIELD OF THE INVENTION

The present invention relates to the field of wireless networking. More specifically, the present invention relates to modifiable field-use secure wireless networks.

### BACKGROUND OF THE INVENTION

In today's computer driven environment, the need for more information and quicker access to information has increased. For many applications, the development of Ethernet networks allowed individuals to pass and exchange information at a high rate. Information and data are shared among a group of computers connected to the network. Multiple networks connect together allowing for a larger number of individuals to gain access to the same information. Whether for business purposes, personal use, or governmental applications, Ethernet networks have become an increasingly utilized resource for rapid access to information and data.

Traditional wired Ethernet networks require multiple numbers of computers hardwired through a single or multiple nodes. Such hardwired networks are effective in areas of static use. A newly constructed office building may have all computers hardwired to an Ethernet hub that remains in a defined location. Such a system can operate transparently in the background to those individuals utilizing the Ethernet network. Wireless networks have become a desirable alternative to wired networks. Wireless technology can bring networks to places where there were previously none. Areas that are not conducive to static systems can utilize a wireless network to connect individuals or multiple networks together. Wired networks are often maintained in an environment that does not fluctuate in temperature or conditions. Wireless networks operate differently and must be able to handle all types of conditions for effective operation in remote locations.

Aside from the ability to operate in various environmental conditions, mobile systems for Ethernet network capabilities face other challenges. Wired networks pass information through hardwired cables. To access the information, a hacker would have to physically tap into a cable or computer on the network. Wireless networks pass information in a very different manner. Wireless networks pass information through radio frequency transmissions. As such, wireless networks are more susceptible to unauthorized reading, capturing, or manipulation of information that is passed. Security protocols and other measures are needed to allow for the secure transmission of data. Secure transmission of data is often a requirement under certain standards, such as military designated Secret status.

A need exists for a deployable wireless networking device that can connect separate networks together and/or act as an access point to multiple wireless users while offering a high level of secure transmission and the ability to operate in different environmental conditions. Military applications need a rapidly deployable unit that can be quickly installed for operation as a network access point in areas that are not designed for wired network applications.

### SUMMARY

Aspects of the present invention overcome one or more of the above limitations and drawbacks by providing a wireless networking apparatus for use in an outdoor or indoor environment. According to an aspect of the invention, a wireless networking apparatus may include a weatherproof housing for protection against different indoor or outdoor conditions, a radio transceiver module, an encryption module, a network router, and a tripod stand for protection and stability. The encryption module may include certification of different types or levels of security. The radio transceiver module may include two radio interfaces for operation in different configurations. The network router may include connectivity circuitry to allow for the wireless networking apparatus to operate as an access point to a plurality of wireless clients, as an access point to a hardwired network, and/or as an end in a point-to-point bridge for connection to a distant network. Each leg of the tripod stand of the wireless networking apparatus may be adjustable for varying the length of the leg.

According to another aspect of the invention, the wireless networking apparatus may include an antenna for receiving and transmitting Internet protocol communication, an integrated power source, and a satellite uplink. The power source may be a uninterrupted power supply for all components within the wireless networking apparatus and/or may be completely internal to or partially exterior to the weatherproof housing. The satellite uplink allows the wireless networking apparatus to communicate with distant networks via satellite communication.

According to another aspect of the invention, two wireless networking apparatuses may be configured to operate as ends to a point-to-point bridge for network connectivity between two separate networks within line-of-sight. Still another aspect of the invention provides for a wireless networking apparatus that may include a weatherproof housing that is specially configured to fit within or be attached to a vehicle for operation while in motion.

These and other features of the invention will be apparent upon consideration of the following detailed description of illustrative embodiments.

### BRIEF DESCRIPTION OF THE DRAWINGS

The present invention will be described by way of illustrative embodiments, but not limitations, illustrated in the accompanying drawings in which like references denote similar elements, and in which:

FIGS. 1A and 1B illustrate block diagrams of a wireless networking device in accordance with at least one aspect of an illustrative embodiment of the present invention;

FIGS. 2A to 2C illustrate examples of a tripod stand for use with a wireless networking device in accordance with at least one aspect of an illustrative embodiment of the present invention;

FIGS. 3A and 3B illustrate novel arrangements for providing network connectivity to a plurality of wireless clients, in accordance with at least one aspect of an illustrative embodiment of the present invention;

FIG. 4 illustrates a novel arrangement for bridging two networks, in accordance with at least one aspect of an illustrative embodiment of the present invention;

FIG. 5 illustrates a novel arrangement for employing wireless encryption, in accordance with at least one aspect of an illustrative embodiment of the present invention;

FIG. 6 illustrates a novel arrangement for utilizing a plurality of wireless networking devices to bypass classified areas, in accordance with at least one aspect of an illustrative embodiment of the present invention;

FIG. 7 illustrates a novel arrangement for satellite uplink communications, in accordance with at least one aspect of an illustrative embodiment of the present invention;

FIG. 8A illustrates a novel arrangement for a wireless networking device that is configured to be housed within a vehicle, in accordance with at least one aspect of an illustrative embodiment of the present invention;

FIG. 8B illustrates a novel arrangement for a wireless networking device that is vehicle mounted, in accordance with at least one aspect of an illustrative embodiment of the present invention.

### DETAILED DESCRIPTION

In the following description of various illustrative embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

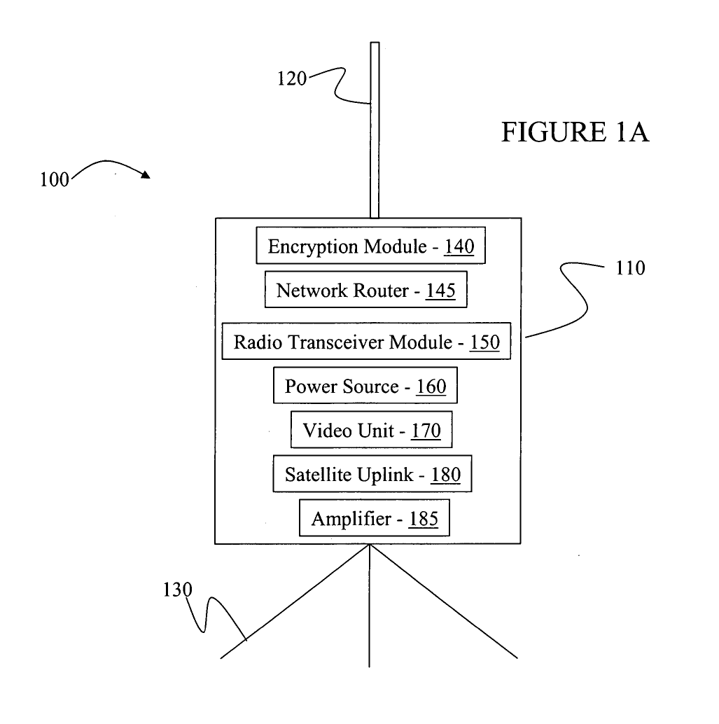

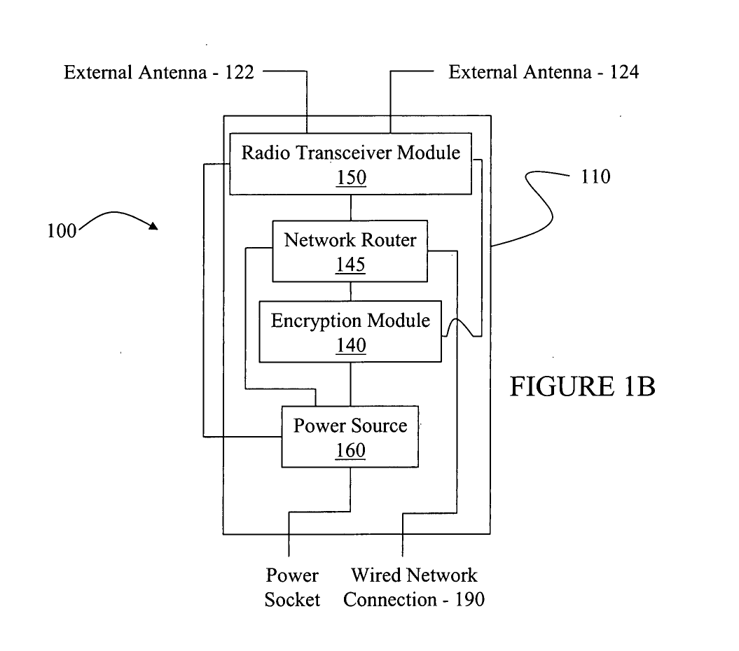

FIG. 1A illustrates a block diagram of a wireless networking device 100 in accordance with at least one aspect of an illustrative embodiment of the present invention. Although wireless networking device 100 is described herein for use in exterior areas, the wireless networking device 100 is not so limited and may be employed in interior locations as well. Wireless networking device 100 may include one or more components. As shown in FIG. 1A, wireless networking device 100 includes an outer housing 110, a communication component 120, and a tripod stand 130. Outer housing 110 is designed to be weather resistant and/or weather proof. Outer housing 110 may include a powder-coated steel or other metallic or hard plastic chassis and a rubber seal to protect the interior components from inclement weather conditions. Rubber sealing allows for the interior components to be protected from moisture and/or debris. Outer housing 110 is designed to protect interior components from cold weather conditions to hot weather conditions as well as from the harsh effects of sand blown conditions to driving rain or snow conditions. Although not shown in FIG. 1A, outer housing 110 may include an opening for permitting access to interior components. The outer housing 110 may be designed with additional openings to permit the replacement or modification of one or more interior components. The openings on the outer housing 110 may be designed with various security mechanisms to protect against unauthorized access to the wireless networking device 100, such as a key required locking mechanism. Outer housing 110 also may include grooves and/or connection points for installation of interior components in a rapid manner. Interchangeable mounting brackets and/or locking mechanisms on the interior of the outer housing 110 may be included to allow for the installation of different types of interior components and/or removal or replacement of interior components in a rapid manner.

One configuration of the outer housing 110 may include dimensions of 11.25 inches (28.125 cm) in width, 4.75 inches (11.875 cm) in depth, and 31.25 inches (78.125 cm) in length. In one example, there are four external connections on the wireless networking apparatus 100. Two (2) standard N-Connectors may be employed for linking two external radio frequency antennas to radio transceiver module 150, as described below. Each N-Connector links into a pigtail inside outer housing 110 connecting directly to one of the two radio interfaces of radio transceiver module 150. One RJ-45 port provides for hardwired connectivity to a network. As described below, the RJ-45 port is connected to radio transceiver module 150 and encryption module 140 through network router 145. Finally, as described below, a power plug connection connects power source 160 to an external generator or power supply.

Communication component 120 may include at least one antenna, a mast and/or an extension for antennas. Although not shown in FIG. 1A, communication component 120 is designed to allow for various height adjustments to the mast and/or the extension. Alternatively, the mast and extension parts may be non-adjustable, allowing for simple and expedited deployment of the wireless networking device 100 in the field. Communication component 120 may include any number of different types of cable for connecting any number of different types of antennas to the wireless networking device 100. For example, using LMR-400 cable, almost any type of standard 2.4 GHz radio frequency antenna may be connected, including various sectoral, omni-directional, parabolic, and directional panel antennas. The mast and extension of the communication component 120 may be connected to a surface by guyed wires to secure the component in conditions of high wind or vibration. One configuration of the mast and extension may include a 3-foot (90 cm) mast with a 4-foot (120 cm) extension.

Communication component 120 may include at least one antenna. Different antennas offer different antenna spreads for improved and overlapping coverage that improves the overall performance. A poor spread can leave frequent dead spots and cause the end user experience to be unsatisfactory. There are several types of antennas that can be utilized to create the antenna spread. Some illustrative examples are: omni-directional, sectoral, directional, parabolic, booster, yagi, and satellite. An omni-directional antenna has a three hundred sixty (360) degree horizontal spread with range depending on the dBi gain of the antenna. In order to obtain greater power, more length is generally required. A sectoral has a limited degree, e.g., one hundred eighty (180) degree, one hundred twenty (120) degree, or ninety (90) degree horizontal spread which provides more signal strength to the area targeted. The power for a sectoral antenna is also a function of the dBi gain. A directional antenna is a small panel antenna that has an approximate four (4) degree coverage spread. Directional antennas are usually employed for point-to-point bridge implementations. A parabolic antenna is a large dish antenna that has high dBi gain and allows for point-to-point bridge connections to span large distances, e.g., up to one hundred (100) miles in Death Valley with four thousand (4000) foot masts. Generally, due to the curvature of the Earth, the point-to-point bridge connection is generally restricted to thirty (30) mile distances. A booster antenna is a small rabbit ear 2 to 3 dBi antenna. A yagi antenna employs a basic antenna element with parasitic reflector and director elements in order to achieve highly directional characteristics. A satellite antenna allows for communication with a satellite or satellites. A satellite antenna can be used for providing a bridge between two networks via a satellite. An example use of a satellite antenna is described below.

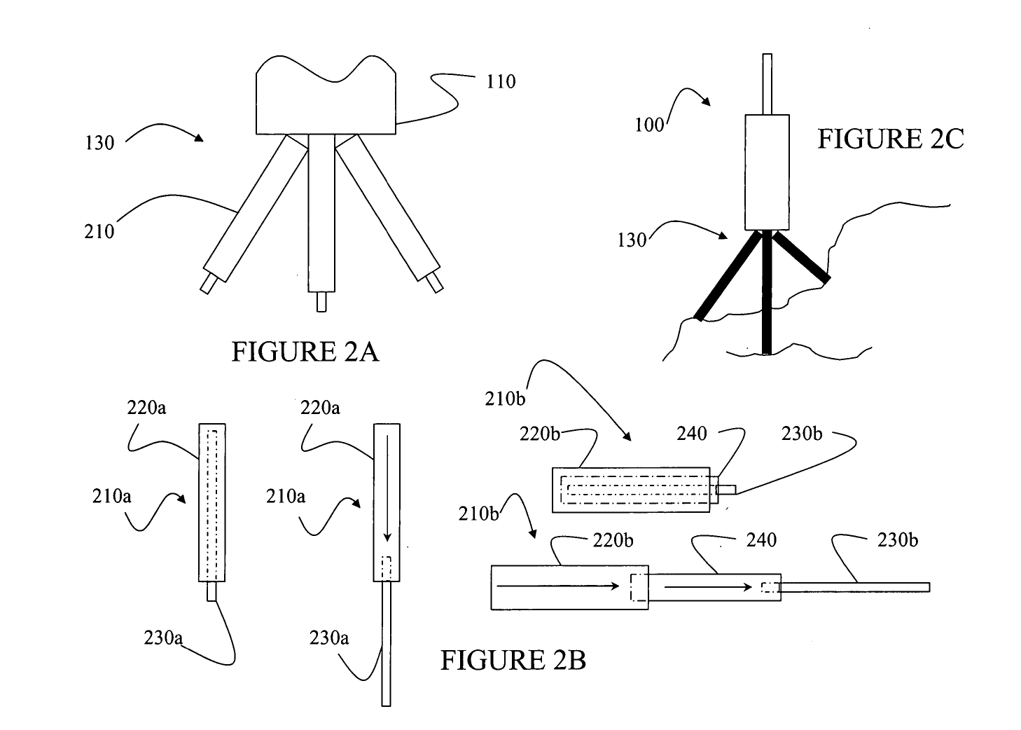

As described below in reference to FIG. 2A-2C, tripod stand 130 raises the outer housing 110 from a surface, thereby protecting the interior components of the outer housing 110 from damaging conditions. For example, a two (2) foot tripod stand 130 would protect against standing water conditions below the wireless networking device 100. Another example would be a condition of snow or sand where an operator would desire that interior components be removed from such harsh elements when possible. Tripod stand 130 further allows for a stable foundation on which the wireless networking device 100 is to reside. A three (3) legged tripod stand 130 extends the area in which the wireless networking device 100 occupies, thereby lowering the occurrence of the wireless networking device 100 tipping over due to wind or vibration. Tripod stand 130 can be staked or weighted to provide additional protection against wind and vibration. One configuration of the tripod stand 130 may include a perpendicular height of 2 feet (60 cm) from ground surface to the point of attachment to outer housing 110.

Wireless networking device 100 can include a number of components secured within outer housing 110. As shown in FIG. 1A, outer housing 110 may include an encryption module 140, a network router 145, a radio transceiver module 150, a power source 160, a video unit 170, a satellite uplink 180, and amplifier 185. Wireless networking device 100 may include any of these components in addition to multiple encryption modules 140, network routers 145, radio transceiver modules 150, power sources 160, video units 170, satellite uplinks 180, and amplifier 185. While FIG. 1A shows various elements in a hierarchical manner, the elements may be connected and configured in an order other than that shown.

Encryption module 140 is designed to enforce network access rights and encrypt/decrypt communication across the wireless network. Access is enforced using a two-pronged security approach. First, each encryption module 140 and wireless client share an Access identification (ID) to segment communications and prevent unauthorized access to the wireless network. The Access ID is unique to each wireless network or groups of wireless networks within the same organization. The Access ID creates a closed architecture in which the encryption modules 140 and wireless clients only pass encrypted traffic from other encryption module 140 enabled devices. Such a configuration prevents unauthorized access and delivers the protection of a firewall. Second, the encryption module 140 enforces the network access rights as defined by an Access Control Server (ACS), as described below. A web based management interface enables customized configuration and easy administration. All essential parameters and statistics are readily available for viewing. Additionally, simple network management protocol (SNMP) monitoring is supported for enterprise networks.

Encryption module 140 can incorporate physical security features and a National Institute of Standards Federal Information Processing Standards 140-1 communications security solution for sensitive but unclassified communication. Encryption module 140 may provide 3DES (Data Encryption Standard) or AES (Advanced Encryption Standard) strong encryption to protect data from unauthorized access. Encryption module 140 may include a Layer 2 encryption device approved by the National Institute of Standards and Technology (NIST) for use when implementing 3DES, 128-bit AES, 192-bit AES, and 256-bit AES. Such an encryption module 140 secures the wireless network by acting as a barrier protecting a wired network from the wireless one. Only clients with authorized software and the correct keys can successfully traverse encryption module 140. With the appropriate software and keys, the experience of using the wireless network is transparent to an end user. The difference between a secure link and a non-secure link is that all packet traffic traversing the wireless link is being encrypted using 3DES or AES and that unauthorized users have no capability to connect to the wired network. Also, any attempt to passively observe packet traffic using a promiscuous wireless packet sniffer or other device to bypass security protocols in an attempt to compromise user accounts and network resources is ineffective against encrypted packets provided through encryption module 140. Encryption module 140 may be modifiable to allow for different encryption standards and/or algorithms, such as, but not limited to a National Institute of Standards Federal Information Processing Standards 140-1 communications security solution.

Encryption module 140 may also include a basic Access Control System (ACS) to block clients that have been identified as compromised, e.g., lost his/her laptop. Software that accompanies an ACS may include an application running on a separate machine that is accessible to the encryption module 140. When installed, the software allows a system administrator to log clients and block individual clients from any or all access. In addition to these functions, encryption module 140 can include a local user/password challenge as well as RADIUS (remote authentication dial-in user service) service.

Encryption module 140 may have various certifications. Encryption module 140 may be certified to operate within a non-secure, sensitive but unclassified environment, e.g., a non-secure Internet protocol router (NIPR) network system. Encryption module 140 may also be certified to operate within a secure environment allowing for the transfer of classified documents via wireless transmission, e.g., a secure Internet protocol router (SIPR) network system. Encryption module 140 could also be certified for use according to military standards for military certification and/or for use according to National Security Agency (NSA) standards for NSA certification, permitting classified Secret designated communication. Different encryption modules 140 with different certifications can quickly and easily be removed and installed into the wireless networking device 100 allowing for immediate upgrade or downgrade in security levels.

In one embodiment, the AirFortress™ Security Gateway by Fortress Technologies® of Oldsmar, Fla. may be utilized as an example of encryption module 140. Two examples of the AirFortress™ Security Gateway include the AF 1100 and the AF6500. Other vendors and/or products may alternatively be utilized to perform the functions of encryption module 140. For the example of an AirFortress™ Security Gateway, the Fortress Technologies® AirFortresS™ Security Gateway comes initialized with a default configuration. Several settings are modifiable, including the IP Address—default IP address of the AirFortress is 192.168.254.254 with a subnet mask of 255.255.255.0, the Access ID—default Access ID is a 16 digit hex string to which the gateway and clients are preset, the Encryption Algorithm—default encryption algorithm is 3DES, the FIPS Certified Mode—by default, FIPS Mode is disabled, and the Username/Password—default username is ‘sysadm’ and the default password is ‘sysadm’. The AirFortress™ Security Gateway is certified by NIST for use on government networks as an encryption device. Encryption module 140 may be designed to support clients using a variety of operating systems.

Radio transceiver module 150 may support networks operating on either the Wi-Fi 2.4 GHz (11 Mbit/s) or 5 GHZ (54 Mbit/s) frequencies. Radio transceiver module 150 may also utilize various radio standards, including the various Institute of Electronics Engineers (IEEE) 802.11 standards for wireless Ethernet. Radio transceiver module 150 may include additional built-in encryption to accompany encryption module 140.

IEEE 802.11b is the established radio standard for wireless Ethernet. The standard operates in the 2.4 GHz frequency band at 11 Mbit/s. IEEE 802.11a standard may also be utilized within radio transceiver module 150. IEEE 802.11a uses orthogonal frequency division multiplexing (OFDM) to provide up to 54 Mbit/s of bandwidth in the 5.8 GHz frequency band. IEEE 802.11a is a standard that offers greater bandwidth for more intensive applications. IEEE 802.11g is another standard that may be utilized within radio transceiver module 150. IEEE 802.11g uses orthogonal frequency division multiplexing (OFDM) to allow increased bandwidth of 54 Mbit/s. The IEEE 802.11g standard is designed to provide the additional bandwidth afforded with IEEE 802.11a in the IEEE 802.11b spectrum so it can also offer backward compatibility with legacy IEEE 802.11b NICs and antennas. IEEE 802.11g operates like a hybrid of the other standards. Because radio transceiver module 150 is not limited to any one standard, it should be appreciated by those skilled in the art that other types of standards may be utilized.

There are several roles for radio transceiver module 150 to provide in a wireless network. Radio transceiver module 150 may operate in a client role as a PCMCIA or universal serial bus (USB) NIC connected to a client personal computer. These clients usually have 1-2 dBi antennas. The range is usually about 250 feet from an access point. Radio transceiver module 150 may operate in an access point role, where the radio transceiver module 150 is configured to enlist and associate clients and bridge the packets to the wired network. An access point role has a set network name (SSID). Radio transceiver module 150 may also operate in a bridge role. In a bridge configuration, a pair of radio transceiver modules 150 may be used to create a wireless link that extends network connectivity between two sites on a point-to-point basis. This allows client networks to bridge back to a root network. Additionally, radio transceiver modules 150 may be used in point-to-multipoint topologies. As a result radio transceiver module 150 can be configured as a root bridge or a client bridge. Finally, radio transceiver module 150 can operate in a repeater role, i.e., where radio transceiver module 150 is configured to be a relay. Such a configuration is often utilized when radio transceiver module 150 is atop a high point between two sites that require connectivity, but do not have line of site for direct communications.

Wired Equivalency Privacy (WEP) is a feature that may be utilized within radio transceiver module 150. WEP can be 128-bit WEP or 64-bit WEP. WEP is a simple RC-4 (encryption/decryption algorithm supported in cellular digital packet data) cipher, which uses static keys to encrypt the wireless datagrams. Hardware application-specific integrated circuits (ASICs) implement the encryption. WEP adds an additional layer of security supporting the certified Layer 2 encryption.

Each IEEE 802.11 standard uses designated radio channels that fall in designated frequencies. The IEEE 802.11b standard uses the 2.4 GHz frequency band to operate. In that band, the standard uses eleven (11) channels as identified in Table 1.

TABLE 1
Channel Designation by Frequency for IEEE 802.11b

| | |
|---|---|
| Channel 1 | 2.412 GHz |
| Channel 2 | 2.417 GHz |
| Channel 3 | 2.422 GHz |
| Channel 4 | 2.427 GHz |
| Channel 5 | 2.432 GHz |
| Channel 6 | 2.437 GHz |
| Channel 7 | 2.442 GHz |
| Channel 8 | 2.447 GHz |
| Channel 9 | 2.452 GHz |
| Channel 10 | 2.457 GHz |
| Channel 11 | 2.462 GHz |

Table 1 identifies only eleven (11) of the available channels. Depending on the country of operation, there can be as many as fourteen (14) channels available, e.g., thirteen (13) in Europe and fourteen (14) in Japan. All available channels operate within a 90 MHz range of the 2.4 GHz band.

The IEEE 802.11a standard uses the 5 GHz frequency band to operate. The channelization of this bandwidth is specific to the regulatory restrictions of different jurisdictions. In the United State, there are three bands for the IEEE 802.11a standard as identified in Table 2.

TABLE 2
Channel Designation by Frequency for IEEE 802.11a
U-NII upper band (5.725-5.825 GHz)

| | |
|---|---|
| Channel 36 | 5.180 GHz |
| Channel 40 | 5.200 GHz |
| Channel 44 | 5.220 GHz |
| Channel 48 | 5.240 GHz |

U-NII middle band (5.25-5.35 GHz)

| | |
|---|---|
| Channel 52 | 5.260 GHz |
| Channel 56 | 5.280 GHz |
| Channel 60 | 5.300 GHz |
| Channel 64 | 5.320 GHz |

U-NII lower band (5.15-5.25 GHz)

| | |
|---|---|
| Channel 149 | 5.745 GHz |
| Channel 153 | 5.765 GHz |
| Channel 157 | 5.785 GHz |
| Channel 161 | 5.805 GHz |

The entire 5 GHz band is usable for IEEE 802.11a implementations but the channels are controlled by regulatory agencies and vary by country.

The IEEE 802.11g standard also uses the 2.4 GHz frequency band to operate as the IEEE 802.11b standard. The IEEE 802.11g implements orthogonal frequency division multiplexing as the IEEE 802.11a standard to achieve data rates of up to 54 Mbit/s. IEEE 802.11g is backward compatible with IEEE 802.11b and can use the same antenna spreads. The frequency bands overlap. The standard uses fourteen (14) channels as identified in Table 3.

TABLE 3
Channel Designation by Frequency for IEEE 802.11g

| | |
|---|---|
| Channel 1 | 2.412 GHz |
| Channel 2 | 2.417 GHz |
| Channel 3 | 2.422 GHz |
| Channel 4 | 2.427 GHz |
| Channel 5 | 2.432 GHz |
| Channel 6 | 2.437 GHz |
| Channel 7 | 2.442 GHz |
| Channel 8 | 2.447 GHz |
| Channel 9 | 2.452 GHz |
| Channel 10 | 2.457 GHz |
| Channel 11 | 2.462 GHz |
| Channel 12 | 2.467 GHz |
| Channel 13 | 2.472 GHz |
| Channel 14 | 2.477 GHz |

Although not shown in FIG. 1A, outer housing 110 may include various plates for easy replacement or modification of the radio transceiver module 150. In the case in which an operator wants to change one type of radio transceiver module 150 for another type, such as an IEEE 802.11b radio transceiver module for an IEEE 802.11a radio transceiver module, an operator can remove the radio transceiver module 150 and the mounting plate on which it rests and simply install a mounting plate for the other type of radio transceiver module 150 and then the new radio transceiver module 150 itself. The outer housing 110 can be specially configured to allow for easy installation of a variety of different internal components.

In one embodiment, the Orinoco AP-2000 by Agere Systems, Inc. of Allentown, Pa. may be utilized as an example of radio transceiver module 150. Other vendors and/or products, e.g., the Aironet®350 Wireless Bridge (AIR-BR-350-A-K9) by Cisco Systems, Inc. of San Jose, Calif., may be utilized to perform the functions of radio transceiver module 150. For the example of an Orinoco AP-2000, the AP-2000 may be configured to operate in the role in which it is needed, e.g., as an end point in a point-to-point bridge, as an access point, and/or as a connection to a satellite uplink.

Device 100 also includes a network router 145. Network router 145 provides network connectivity to a hardwired Ethernet network, another wireless network through an antenna, and/or to another wireless networking device 100. Network router 145 forwards data along networks. Network router 145 may include a switch interface between two networks and/or a physical bus and ports connected to individual terminal devices either through wired or wireless communication paths. It should be understood by those skilled in the art that encryption module 140, network router 145 and radio transceiver module 150 or portions of each may be included within the same device and/or housing.

Power source 160 may be separate from and/or included within outer housing 110. Power source 160 may include an uninterrupted power supply of 110 volts, 220 volts, or an automatic dynamic voltage sensing supply. The uninterrupted power supply can provide power to each electrical component of the wireless networking device 100 as needed. Still further, power source 160 may be connected to a generator (not shown) exterior to the outer housing 110. Although not shown in FIG. 1A, wireless networking device 100 may include a back-up power source as a reserve in the instance in which a power failure occurs to power source 160. In addition, solar cells (not shown) may be utilized with wireless networking device 100, allowing for the supply of needed electricity to power source 160. In one embodiment, an uninterrupted power supply by Liebert Corporation of Columbus, Ohio may be utilized as an example of power source 160.

Video unit 170 may include a camera and a video server. The camera of the video unit 170 can capture images, which are subsequently translated by the video server into Internet protocol communication for further transmission by the wireless networking device 100. Video unit 170 can capture still images or live feeds for transmission. Although not shown in FIG. 1A, the camera of the video unit 170 may be external to the outer housing 110 and can further be mounted on a separate mast or extension rod extending from the external housing as needed. Various types of configurations for attaching a camera of the video unit 170 may be employed. In one embodiment, a camera by Pelco® of Clovis, Calif. may be utilized as an example of the camera and a video server by Axis® Communications of Chelmsford, Mass. may be utilized as an example of the Internet protocol video server in the video unit 170.

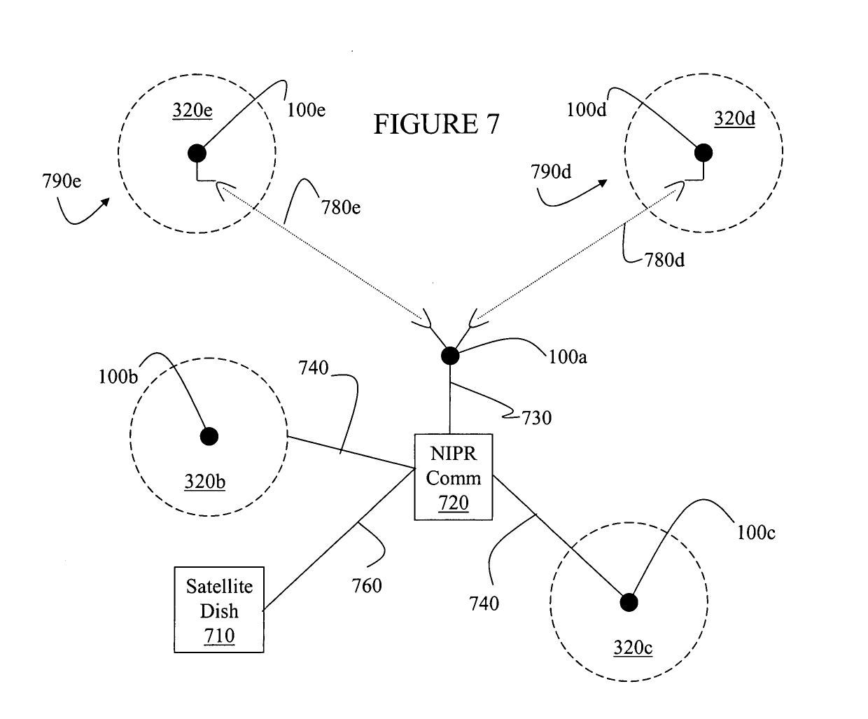

Satellite uplink 180 allows for communication with remote sites that are accessible by satellite, such as remote networks that are not within line of sight of wireless networking device 100. An example configuration and use of the satellite uplink 180 is described below with reference to the illustrative example shown in FIG. 7 (described below). Amplifier 185 may be used to strengthen signals from repeater nodes. Noise or distortion of the signal can be caused by electromagnetic interference, radio frequency interference, frequency shifts internal to a circuit, and various other factors. Amplifier 185 is capable of reading the signal, reshaping it to its proper form, and retransmitting the signal. It should be understood by those skilled in the art that one or more of the encryption module 140, radio transceiver module 150, power source 160, video unit 170, satellite uplink 180, and amplifier 185 may be physically located in a separate housing or between outer housing 110 and a separate housing. In one embodiment, a satellite uplink by Mackay Communications, Inc. of Raleigh, N.C., Telenor ASA of Formebu, Norway, or Segovia, Ltd. of McLean, Va. may be utilized as an example of satellite uplink 180.

FIG. 1B is an illustrative example of the connections between various components of wireless networking device 100. Within outer housing 110, radio transceiver module 150, network router 145, and encryption module 140 are powered by power source 160. Power source 160 is shown to have a connection to a power socket. This may be an example of an external generator. As shown, radio transceiver module 150 may be connected to two (2) separate external antennas, 122 and 124. In one example, two (2) standard N-Connectors may be employed for linking the two external radio frequency antennas 122 and 124 to radio transceiver module 150. Each N-Connector links into a pigtail inside outer housing 110 connecting directly to one of the two radio interfaces of radio transceiver module 150. As used herein, radio 1 is described as the components of radio transceiver module 150 associated with external antenna 122 and radio 2 is described as the components of radio transceiver module 150 associated with external antenna 124.

Radio transceiver module 150 may be shown connected to encryption module 140 and network router 145. Encryption module 140 may be connected to a wired network connection 190. Wired network connection 190 may include an RJ-45 connector to link the wireless networking device into a wired network. Wireless clients may communicate with each other without going through the access point onto the wired network, while servers can still be connected on a shared hardwired Ethernet media. Wireless networking device 100 complements the existing wired network. It should be understood that encryption module 140, network router 145, and/or radio transceiver module 150 may physically reside within the same device or within one unit.

Referring to FIG. 2A-2C, illustrative examples of tripod stand 130 are shown for use with wireless networking device 100 in accordance with at least one aspect of an illustrative embodiment of the present invention. FIG. 2A illustrates an example of tripod stand 130 connected to outer housing 110. The three (3) legs 210 of tripod stand 130 are shown to allow for various adjustments in the length of each leg. It should be understood by those skilled in the art that the legs 210 of tripod stand 130 alternatively may be designed to be one length with no adjustment capabilities. FIG. 2B illustrates two examples of configurations allowing for adjustment of the length of each leg 210 of tripod stand 130. Tripod leg 210a is shown in two perspectives. In one perspective, a leg housing 220a is shown with inner extension 230a. The dashed line indicates the outline of the inner extension 230a and a directional arrow indicates that the inner extension can slide out of the leg housing 220a. Adjustable levels and/or components could be included with leg 210 allowing a user to set the particular leg 210 to any of a variety of different lengths, e.g., by inserting a placement pin to hold the tripod leg at a specific length.

FIG. 2B also illustrates how a leg 210b could include an intermediate extension 240 between the leg housing 210b and the inner extension 230b. Any number of intermediate extensions 240 may be employed with tripod stand 130 and the configurations illustrated in FIG. 2B are but two examples. FIG. 2C illustrates an example of a configuration for tripod stand 130 with varying lengths for each leg 210. FIG. 2C illustrates an example of how the wireless networking device 100 may be deployed in an area that does not have a flat or level surface. By varying the lengths of each leg 210 of tripod stand 130, a particular angle can be configured, allowing a user to easily deploy the wireless networking device 100 in the field on various types of ground conditions.

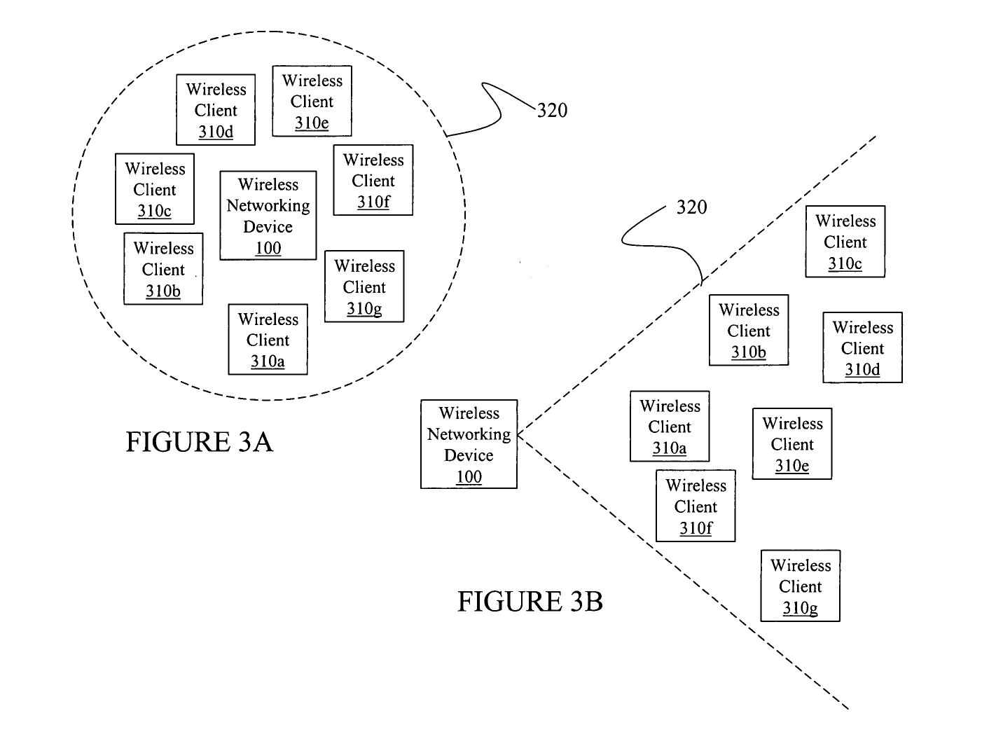

Wireless networking device 100 may perform different roles depending upon its configuration. FIGS. 3A and 3B illustrate examples of configurations in which the wireless networking device 100 operates as an access point. Referring to FIG. 3A, wireless networking device 100 as an access point, can associate clients and bridge them to a hardwired network or relay information to other wireless clients. FIG. 3A illustrates an example of wireless networking device 100 operating as an access point utilizing an omni-directional antenna. The dashed line circle is representative of the approximate coverage area 320 of the antenna of the wireless networking device 100. Wireless clients 310a-310g that reside within the coverage area 320 of the omni-directional antenna of the wireless networking device 100 can utilize the wireless networking device 100 as an access point for connection to a wired network attached to the wireless networking device 100 or as a bridge for connection to another wireless access point. Referring now to FIG. 3B, an example of wireless networking device 100 operating as an access point utilizing a ninety (90) degree sectoral antenna is shown. The dashed lines are representative of the coverage area 320 of the antenna of the wireless networking device 100. Wireless client 310a-310 g that reside within the coverage area 320 of the ninety (90) degree sectoral antenna of the wireless networking device 100 can utilize the wireless networking device 100 as an access point for connection to a wired network attached to the wireless networking device 100 or as a bridge for connection to another wireless access point.

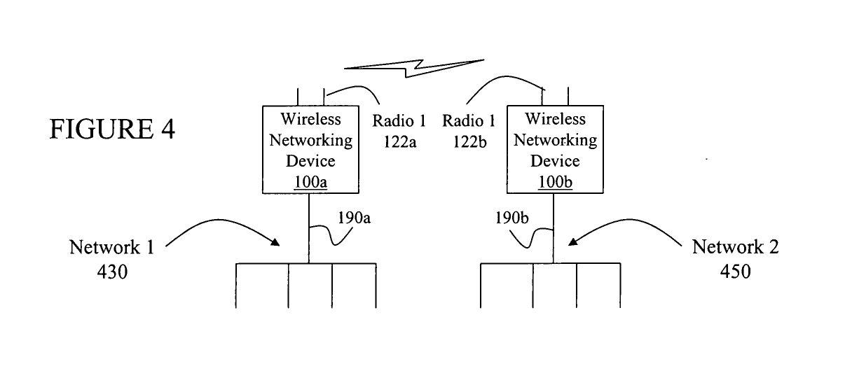

As a bridge, wireless networking device 100 can extend network connectivity to a remote location that is within line-of-sight via a point-to-point bridge link. FIG. 4 illustrates an example of how two (2) wireless networking devices 100a and 100b can operate as a point-to-point bridge. Wireless networking device 100a includes a first radio 122a, and may be connected to a first network 430 via hardwired network connection 190a. Wireless networking device 100b includes a first radio 122b and may be connected to second network 450 via hardwired network connection 190b. First radios 122a and 122b may use parabolic grid antennas positioned to transmit to and receive information from each other. Each wireless networking device 100a and 100b may include and use second radios (not shown) as access points for wireless connectivity by clients, as illustrated with respect to FIGS. 3A and 3B. Alternatively, second radios may be used to connect to first and second networks instead of being used as access points.

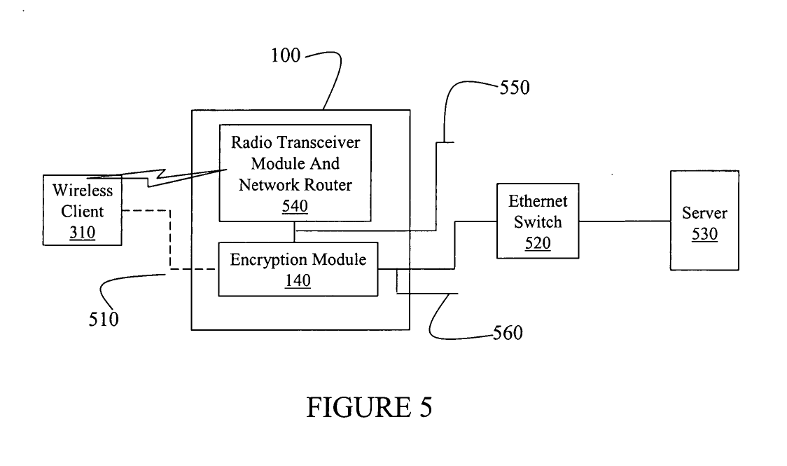

FIG. 5 illustrates a novel arrangement for employing wireless encryption, in accordance with at least one aspect of an illustrative embodiment of the present invention. Radio transceiver module and network router module 540 is connected to encryption module 140. Encryption module 140 is further connected to Ethernet switch 520, which in turn is coupled to a server 530. Encryption module 140 injects Layer 2 encryption via communication received over wireless link 510 into the network stack of the wireless client 310. All traffic transmitted over the IEEE 802.11×wireless communication is encrypted IP packets inside a Layer 2 Ethernet frame. A hacker observing the data would see Ethernet header information and encrypted bits. No IP header or any of the payload would be visible without decryption. 3DES and AES are more secure than 128-bit WEP security built into most wireless access points. Although the WEP keys provide some security, because the keys are not changed, once a hacker cracks the key, he/she can view all of the data transmitted and potentially get any information at will. Encryption module 140 may be more robust than traditional IPSec 3DES tunnels in that it can recover automatically from intermittent network conditions. In addition, clients can roam between access points and not have to renegotiate the encryption tunnel. Encryption module 140 can scramble the data as it traverses the wireless link 510. External port 550 may be a non-secure port while internal port 560 may be a secure port.

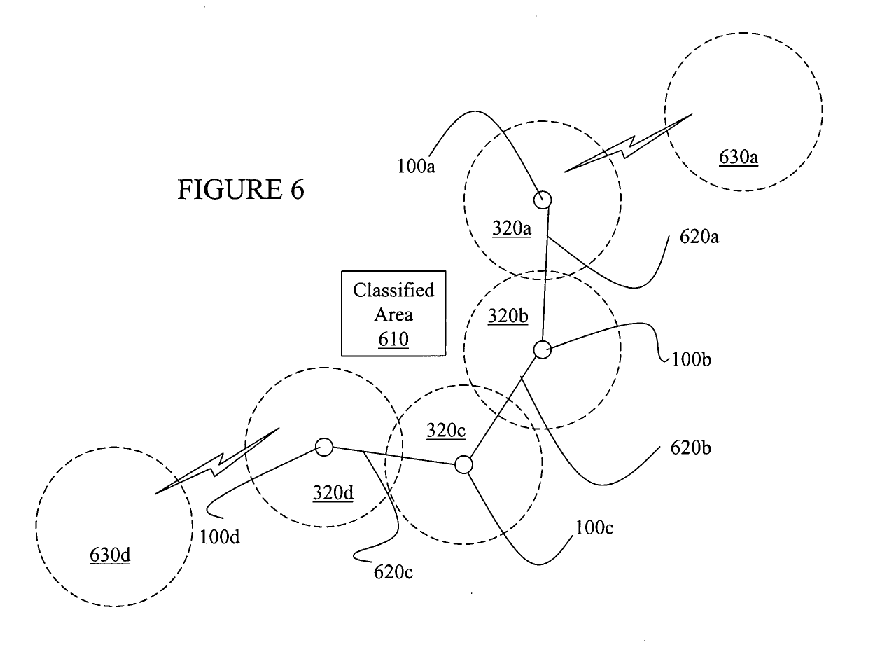

FIG. 6 illustrates a novel arrangement for utilizing a plurality of wireless networking devices to bypass classified areas, in accordance with at least one aspect of an illustrative embodiment of the present invention. Wireless networking devices 100a-100d can be configured to bypass a classified area 610. Each wireless networking device 100a-100d has a coverage area 320a-320d, respectively, allowing for wireless clients within the respective coverage area 320 to access the wireless networking device 100. Each wireless networking device 100a-100d can further be hardwire connected 620a-620c to each other as shown. Such a configuration allows for communication around a classified area 610 without compromising the security protocols of the classified area 610. Wireless networking devices 100a and 100d may be connected to respective satellite networks 630a and 630d as identified. By configuration of each wireless networking device 100a-100d, an operator can coordinate wireless networking transmissions and communications so they do not inhibit the security features and protocols of classified area 610.

FIG. 7 illustrates a novel arrangement for satellite uplink communications, in accordance with at least one aspect of an illustrative embodiment of the present invention. Wireless networking device 100a provides a hardwired connection to NIPR communication point 720 via connection 730 and a wireless bridge to remote sites 790d and 790e. Wireless networking device 110a may communicate with wireless networking devices 100d and 100e via parabolic antennas over communication paths 780d and 780e respectively. Wireless networking devices 100a, 10b, and 100c may be hardwired to a NIPR communication point 720 via connections 730, 740, and 750, respectively. NIPR communication point 720 may be a command point for accessing information across the various networks and overseeing both security and performance of the networks. Satellite link 760 allows for the transmission to a satellite dish 710 through the NIPR communication point 720. As shown, each of wireless networking devices 100b and 100c includes coverage area 320b and 320c respectively for connecting wireless clients (not shown).

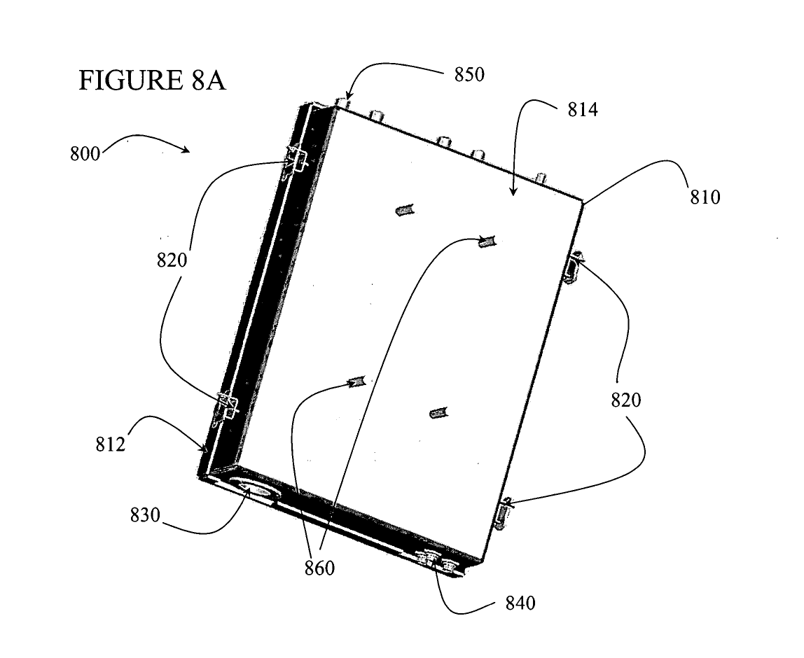

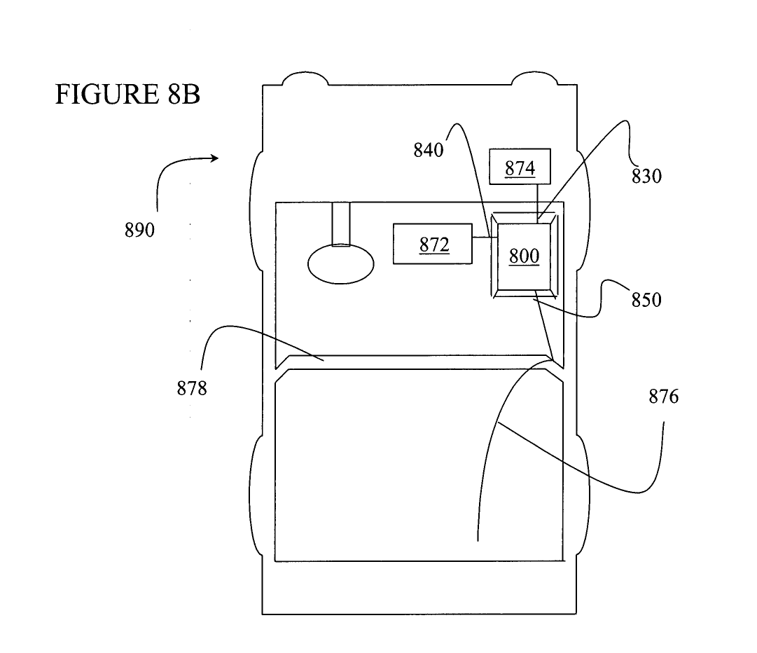

FIG. 8A illustrates a novel arrangement for a wireless networking device 800 that can be vehicle mounted, in accordance with at least one aspect of an illustrative embodiment of the present invention. Wireless networking device 800 is shown to include an outer housing 810. Locking mechanisms 820 can secure the outer housing 810 of the wireless networking device 800 to prevent unauthorized access. As shown locking mechanisms 820 can secure one portion 812 of the wireless networking device 800 to a second portion 814. Portion 812 can be the front of the wireless networking device 800 that can be removed for maintenance and modification purposes. Access portal 830 provides a point for supplying power to the wireless networking device 800 from an external source. Connections 840 provide a connection to devices utilizing the network. For example, a device may be connected at connection 840 for access the wireless networking device 800. Connections 850 provide connection to the antenna(s) (not shown) for transmission and receipt of signals associated with the wireless networking device 800. Finally, multiple connection points 860 are shown as illustrative examples of bolts for mounting inside the housing or opening of a vehicle for wireless mobile capability.

FIG. 8B illustrates a novel arrangement for a wireless networking device 800 that is vehicle 890 mounted, in accordance with at least one aspect of an illustrative embodiment of the present invention. Vehicle 890 is shown with a wireless networking device 800 attached within a opening or housing of the vehicle 890. As shown, vehicle 890 includes a battery 874 and a roll bar 878. Vehicle 890 is shown to include a roll bar 876; however, it should be understood by those skilled in the art that a roll bar 878 is not needed to operate with the present invention and is merely shown for illustrative purposes. Wireless networking device 800 is coupled to the frame or body of the vehicle 890 by physical connection points, such as connection points 860. Antenna 876 is coupled to the wireless networking device 800 through connections 850. Antenna 876 is shown as being mounted to the roll bar 878 of the vehicle 890. Power to the wireless networking device 800 from an external source, battery 874, is supplied through connection 830. Finally, FIG. 8B shows a connection to a hardwired network device 872. Hardwired network device 872 may include a consol device, such as a separate computer including a display and input device, on the vehicle 890 for allowing a user to access the network to which wireless networking device 800 is connected. Such a configuration allows a user to access information through the network while in motion to a destination. Vehicle 890 is shown to be a land oriented vehicle, such as a humvee; however, it should be understood by those skilled in the art that vehicle 890 may include any type of vehicle, including a helicopter, boat, all terrain vehicle, tank, and hovercraft.

Wireless networking device 100 is designed to allow for rapid deployment in the field under a variety of environmental conditions. Wireless networking device 100 can be disassembled and stored into a case for transfer to another location. The case may be a foam injected, custom cut, hard plastic or metal case to provide protection during transport and shipping. One configuration for the case may include dimensions of 35 inches (87.5 cm) in height, 27 inches (67.5 cm) in width, and 57 inches (142 cm) in length. An operator can assemble the components of the wireless networking device 100 rapidly in the field, even within a few minutes. Each component of the wireless networking device 100 is designed for easy installation and connection to other components. The wireless networking device 100 can be integrated with existing wireless networks and equipment or it can be used to implement and deploy networks where none previously existed.

As the wireless networking device 100 is designed for flexibility, a number of different permutations may be employed that allow the wireless networking devices 100 to be utilized in a variety of network topologies. While the methods and systems of the present invention have been described in terms of the above illustrated embodiments, those skilled in the art will recognize that the various aspects of the present invention can be practiced with modification and alteration within the spirit and scope of the appended claims. The description is thus to be regarded as illustrative instead of restrictive of the present invention. For example, each of the elements of the aforementioned embodiments may be utilized alone or in combination with elements of the other embodiments. There are any number of alternative combinations for defining the invention, which incorporate one or more elements from the specification, including the description, claims, and drawings, in various combinations or sub-combinations. It will be apparent to those skilled in the relevant technology, in light of the present specification, that alternate combinations of aspects of the invention, either alone or in combination with one or more elements or steps defined herein, may be utilized as modifications or alterations of the invention or as part of the invention. It is intended that the written description of the invention contained herein covers all such modifications and alterations.

1. A wireless networking system, comprising:
a weatherproof housing, wherein the housing encloses:
a radio transceiver module,
a network router, coupled to the radio transceiver module, and
an encryption module, coupled to the network router; and
a securing device connected to the weatherproof housing.

2. The wireless networking system of claim 1, wherein the securing device comprises a tripod stand.

3. The wireless networking system of claim 2, wherein each leg of the tripod stand is independently adjustable in length.

4. The wireless networking system of claim 1, further comprising a first antenna, coupled to the radio transceiver module, for receiving and transmitting Internet protocol data.

5. The wireless networking system of claim 4, further comprising a second antenna, coupled to the radio transceiver module, for receiving and transmitting Internet protocol data.

6. The wireless networking system of claim 5, wherein the first antenna is configured to operate as a wireless access point and the second antenna is configured to operate as an endpoint of a wireless bridge.

7. The wireless networking system of claim 5, wherein the second antenna comprises a satellite uplink.

8. The wireless networking system of claim 7, wherein the first antenna is configured to operate as a wireless access point.

9. The wireless networking system of claim 1, further comprising a power source.

10. The wireless networking system of claim 9, wherein the power source comprises a UPS, and is connected to a generator, external to the weatherproof housing.

11. The wireless networking system of claim 9, wherein the power source comprises a UPS, and is connected to a solar panel, external to the weatherproof housing.

12. The wireless networking system of claim 1, further comprising:
a camera; and
a video server, coupled to the camera, for translation of video received through the camera to Internet protocol data, and for communicating the translated video IP data to the network router.

13. The wireless networking system of claim 1, wherein the encryption module is certified for NSA certified encryption for classified secret communication.

14. The wireless networking system of claim 1, wherein the encryption module is certified for NIST 140 certified encryption.

15. The wireless networking system of claim 1, wherein the network router and the radio transceiver module are physically located within one device.

16. The wireless networking system of claim 1, wherein the securing device couples the weatherproof housing to a vehicle.

17. The wireless networking system of claim 16, wherein the securing device attaches to a preexisting opening in the vehicle.

18. The wireless networking system of claim 16, further comprising a power source, wherein the power source comprises a UPS, and is connected to a battery of the vehicle, external to the weatherproof housing.

19. The wireless networking system of claim 1, wherein the network router is coupled to a wired network connection.

20. The wireless networking system of claim 1, wherein the network router and the encryption module are physically located within one device.

21. A wireless networking apparatus, comprising:
a weatherproof housing, wherein the housing encloses:
a radio transceiver module comprising first and second radio transceivers for communicating IP data,
a network router, coupled to the radio transceiver module, for routing the IP data,
an encryption module for encrypting/decrypting the IP data, and
a UPS for powering the radio transceiver module, network router, and the encryption module;
a tripod stand coupled to the weatherproof housing; and
first and second antennas for receiving and transmitting Internet protocol data coupled to the first and second radio transceivers, respectively,
wherein the encryption module is certified for NSA certified encryption for classified secret communication,
wherein the first transceiver and first antenna are configured to provide wireless access point services.

22. A wireless networking apparatus, comprising:
a weatherproof housing, wherein the housing encloses:
a radio transceiver module comprising first and second radio transceivers for communicating IP data,
a network router, coupled to the radio transceiver module, for routing the IP data,
an encryption module for encrypting/decrypting the IP data, and
a UPS for powering the radio transceiver module, network router, and the encryption module;
a securing device, connected to the weatherproof housing, that couples the weatherproof housing to a vehicle; and
first and second antennas for receiving and transmitting Internet protocol data coupled to the first and second radio transceivers, respectively,
wherein the encryption module is certified for NSA certified encryption for classified secret communication,
wherein the first transceiver and first antenna are configured to provide wireless access point services.
